(19) United States
(12) Patent Application Publication
(10) Pub. No.: US 2014/0287809 A1
(43) Pub. Date: Sep. 25, 2014

(54) NO COMMISSION PAI GOW POKER

(71) Applicant: Derek J. Webb, Derby (GB)

(72) Inventor: Derek J. Webb, Derby (GB)

(21) Appl. No.: 14/164,025

(22) Filed: Jan. 24, 2014

Related U.S. Application Data
(63) Continuation of application No. 11/924,265, filed on Oct. 25, 2007, now abandoned.
(60) Provisional application No. 60/855,290, filed on Oct. 30, 2006.

(51) Int. Cl. G07F 17/32; A63F 1/00

(52) U.S. Cl. CPC G07F 17/3293; A63F 1/00; G07F 17/3244; A63F 2001/005
USPC 463/13; 273/292

(57) ABSTRACT

A method of playing a Pai Gow Poker game includes the steps of (a) dealing cards to a player and to a dealer; (b) the player and dealer dividing their cards into first and second player hands and first and second dealer hands, respectively; and (c) resolving the game based on a comparison of the first and second player hands with the first and second dealer hands. The resolving step is practiced differently depending on whether one of the first and second player hands includes a Joker or alternatively is below or exceeds a predetermined hand rank.

### CROSS-REFERENCES TO RELATED APPLICATIONS

This application claims the benefit of U.S. Provisional Patent Application Ser. No. 60/855,290, filed Oct. 30, 2006, the entire content of which is herein incorporated by reference.

### STATEMENT REGARDING FEDERALLY SPONSORED RESEARCH OR DEVELOPMENT

(Not Applicable)

### BACKGROUND OF THE INVENTION

The present invention relates to a casino poker game and, more particularly, to a casino Pai Gow poker game where the house commission for winning hands is eliminated.

Pai Gow Poker is normally played in a casino or card club environment. The game was originally based on Chinese Dominoes or Pai Gow, and the card version may be known by other names such as Asian Poker and Double Hand. The deck is a regular 52-card deck with a Joker added comprising a total 53-card deck. The game may be played by up to six players and one bank with the dealer commonly being the banker in a casino, and a player commonly being the banker in a card club. The text assumes dealer as banker for simplicity.

Although Double Hand is growing significantly, the game has certain rituals and practices that tend to slow the game pace. In particular, the use of commission on winnings to generate a house advantage is detrimental to a fast dealing pace.

A bet is made before cards are dealt. Each player is dealt seven cards and forms a five-card high hand and a two-card low hand. The five-card hand is based on normal poker rankings, and the two-card hand is based on pairs and high cards. The two-card hand must not be higher than the five-card hand. Each player hand is compared to the corresponding dealer hands. To win the bet, both hands must win, and to lose the bet, both hands must lose. If one hand wins and one loses, it is a tie, known as push.

The house advantage is generated by two means. Firstly, a commission as a percentage of winnings is paid on all winning hands, usually 5%. Secondly, the house wins all copy hands, that is, where either the high or low hand is tied. Thus, the player with a copy and a loss loses, while the player with a copy and a win pushes.

While Pai Gow Poker is popular, it is a complex game to learn how to deal. The use of commission also adds a level of complexity to the game. The game is already a slow game and calculating and deducting commission makes for an even slower game.

### BRIEF SUMMARY OF THE INVENTION

The most valuable card to the player in Pai Gow is the Joker. A player with a Joker is more likely to have a winning hand than a player without a Joker. This concept can be more easily appreciated if considering a player playing heads-up against the dealer. If the player has the Joker, then the dealer does not. If the player does not have the Joker, then there is obviously a chance that the dealer will have the Joker.

One concept described herein differentiates between players winning with a Joker and players winning without a Joker. When a player wins without a Joker, there is no commission on winnings, and the player bet is paid 1 to 1, for example. When a player wins with a Joker, the payout may be less than 1 to 1.

In an alternative playing mode, the payout for a winning hand above a certain hand rank may be 1 to 1, while the payout may be reduced if the player hand is less than the certain hand rank. Conversely, the payout for a winning hand below a certain hand rank may be 1 to 1, while the payout for a player hand above the certain hand rank may be less than 1 to 1.

In an exemplary embodiment, a method of playing a Pai Gow card game includes the steps of (a) dealing cards to a player and to a dealer; (b) the player and dealer dividing their cards into first and second player hands and first and second dealer hands, respectively; and (c) resolving the game based on a comparison of the first and second player hands with the first and second dealer hands, wherein the resolving step is practiced differently depending on whether one of the first and second player hands includes a Joker. Prior to step (a), the method may include a step of receiving a wager from the player, where step (c) is practiced by paying a payout on the wager if the game is resolved in favor of the player. In this context, step (c) may be practiced by paying a lower payout on the wager, such as less than 1 to 1, if the game is resolved in favor of the player and one of the first and second player hands includes the Joker. Step (c) may be practiced by paying a payout of 1 to 1 on the wager if the game is resolved in favor of the player and neither of the first and second player hands includes the Joker. In this context, the payout may be one of 9 to 10, 4 to 5, 7 to 10, 3 to 5, or 1 to 2.

In one operating mode, step (a) is practiced by dealing seven cards to the player and seven cards to the dealer, where the first and second player hands and the first and second dealer hands consist of hands of five cards and two cards, respectively. In this context, step (c) may be practiced by paying a different payout depending on whether the Joker forms part of the five-card first hand or the two-card second hand. For example, step (c) may be practiced by paying a payout up to 1 to 1 if the Joker for part of the five-card first hand and by paying a payout below 1 to 1 if the Joker forms part of the two-card hand. In this context, the payout below 1 to 1 may be one of 9 to 10, 4 to 5, 7 to 10, 3 to 5, 1 to 2 or 2 to 5.

In another exemplary embodiment, in a method of resolving wagers on winning player hands in Pai Gow Poker, each player and the dealer are dealt a total of seven cards, and the seven cards are divided into a five-card hand and two-card hand. The method includes one of paying a payout below 1 to 1; paying a payout below 1 to 1 if the five-card hand includes a Joker and 1 to 1 if the two-card hand includes the Joker; paying a payout of 1 to 1 if the five-card hand includes a Joker and below 1 to 1 if the two-card hand includes the Joker; paying a payout of 1 to 1 if at least one of the five-card hand and the two-card hand have a hand rank exceeding a predetermined hand rank and otherwise paying a payout below 1 to 1; and paying a payout of 1 to 1 if at least one of the five-card hand and the two-card hand have a hand rank below a predetermined hand rank and otherwise paying a payout below 1 to 1.

In still another exemplary embodiment, a method of playing a Pai Gow card game includes the steps of (a) dealing cards to a player and to a dealer; (b) the player and dealer dividing their cards into first and second player hands and first and second dealer hands, respectively; and (c) resolving the game based on a comparison of the first and second player hands with the first and second dealer hands, wherein the resolving step is practiced differently depending on a hand rank of one of the first and second player hands. Step (c) may be practiced differently depending on whether the hand rank of the one of the first and second player hands exceeds a predetermined hand rank or is lower than a predetermined hand rank.

In one operating mode, prior to step (a), the method includes receiving a wager from the player, where step (c) is practiced by paying a payout on the wager if the game is resolved in favor of the player. In this context, the payout may be 1 to 1 if the hand rank of the one of the first and second player hands exceeds a predetermined hand rank and otherwise paying a payout below 1 to 1, which may be 3 to 5. Alternatively, the payout may be 1 to 1 if the hand rank of the one of the first and second player hands is below a predetermined hand rank and otherwise paying a payout below 1 to 1.

The resolving step in this embodiment may also be practiced differently depending on whether one of the first and second player hands includes a Joker.

### BRIEF DESCRIPTION OF THE DRAWINGS

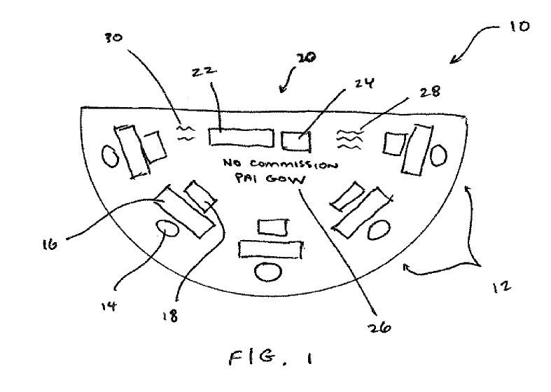

These and other aspects and advantages will be described in detail with reference to the accompanying drawing, in which FIG. 1 shows an exemplary table layout for the Pai Gow poker game described herein.

### DETAILED DESCRIPTION OF THE INVENTION

FIG. 1 shows a playing surface or table layout 10 that is suitable for the game described herein. The layout 10 includes a plurality of player areas 12. Although five player areas 12 are shown on the table layout 10, more or fewer player areas 12 may be included. In a conventional Pai Gow poker game, a maximum of six players may play at one time.

Each player area 12 includes a wager area 14, a high hand area 16 and a low hand area 18. The layout also includes a dealer area 20 having a dealer high hand area 22 and a dealer low hand area 24. The layout 10 is provided with promotional markings 26, game rules 28, payout scales 30, and the like.

Game play and rules of Pai Crow Poker are known, and details thereof will not be described. Generally, each player and the dealer are dealt seven cards. The player(s) and dealer divide the cards into two hands, including a 5-card hand and a 2-card hand. The 5-card hand must have a Poker rank that is not lower than the 2-card hand As noted above, in order for the player to win, both the 5-card hand and the 2-card hand must beat the dealer's 5-card hand and 2-card hand, respectively.

One embodiment of the invention differentiates between players winning with a Joker and players winning without a Joker. With the game described herein, when a player wins without a Joker, there is no commission on winnings, and the player bet is paid 1 to 1. When a player wins with a Joker, there is a payout of less than 1 to 1. An example of such a payout could be 4 to 5. This could also be considered to be 20% commission; however, it would not have the same effect of slowing the game down as a 5% commission.

For example on a $5 bet at 4 to 5, the payout of $4 would be made in regular $1 casino chips. With a 5% commission, this would require paying $4.75, which means that 0.25 cent coins need to be stored in the chip tray. Whereas every winning bet needs commission processing in the traditional game, with the present embodiment, all winning bets are paid 1 to 1 other than a player winning with a Joker, who is paid less than 1 to 1.

Alternative embodiments/playing modes modify the house advantage. In one simpler methodology, the payout for a winning hand with a Joker is always less than 100% of the wager, that is less than 1 to 1, for example 4 to 5. In another alternative embodiment, the payout is below 1 to 1 if the five-card hand includes a Joker and 1 to 1 if the two-card hand includes the Joker. The payout may alternatively be 1 to 1 when a Joker is used in the 5-card hand, but less than 1 to 1, for example 3 to 5, when a Joker is used in the 2-card hand. In still another alternative, the payout for a winning hand above a certain hand rank is 1 to 1, and the payout is less, for example 3 to 5, when the player hand is less than the certain hand rank. Conversely, the payout for a winning hand below a certain hand rank may be 1 to 1, while the payout is less than 1 to 1, for example 3 to 5, when a player has more than the certain hand rank. The latter two playing modes are viable regardless of whether the Joker is used in defining the player hand rank.

The methodology described herein actually creates a player perception that the game is now more fair. As the player without a Joker is at a disadvantage, it seems appropriate to pay 1 to 1 (i.e., without commission). As the player with a Joker is at an advantage, it seems appropriate to pay that player less than 1 to 1.

As would be apparent to one skilled in the relevant art, the game can be embodied in a wide variety of forms and media including, but not limited to, single player slot video machines, multi-player slot video machines, electronic games and devices, lottery terminals, scratch-card formats, software as well as in-flight, home, and Internet entertainment. In addition, the game can be readily implemented as a computer program product (e.g., floppy disk, compact disc (CD), etc.) comprising a computer readable medium having control logic recorded therein to implement the features herein as described in relation to the preferred embodiments. The control logic can be loaded into the memory of a computer and executed by a central processing unit (CPU) to perform the operations described herein.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1-20. (canceled)

21. A method of providing a Pai Gow card game to one or more players comprising the steps of:
a) receiving a wager from a player;
b) dealing cards to a player and to a dealer from at least one randomly-ordered standard fifty-two card deck with at least one Joker included therein;
c) permitting the player and dealer to divide their cards into first and second player hands and first and second dealer hands, respectively, each of the first and second player hands and the first and second dealer hands having a respective hand rank;
d) comparing the first and second player hands ranks with the first and second dealer hands ranks; and
e) responsive to the rank of the first and second player hands outranking the first and second dealer hand ranks, awarding one of a first payout amount based on the wager received if neither one of the first and second player hands includes a Joker and a second payout amount based on the wager received if either one of the first and second player hands includes a Joker, wherein the first payout amount is greater than the second payout amount.

22. A method according to claim 21, wherein the first payout amount is equal to or greater than the amount of the wager received and second payout amount is less than the amount of the wager received.

23. A method according to claim 21, wherein the second payout amount is less than 1 to 1 when compared with the amount of the wager received.

24. A method according to claim 21, wherein the second payout amount is one of 9 to 10, 4 to 5, 7 to 10, 3 to 5, or 1 to 2.

25. A method according to claim 21, wherein steps c) and d) are practiced by dealing seven cards to the player and seven cards to the dealer, and permitting the player and dealer divide their cards into first and second player hands and the first and second dealer hands consisting of hands of five cards and two cards, respectively.

26. A method according to claim 21, wherein the second payout amount depends on whether the Joker is in the first or second player hand.

27. A method according to claim 21, wherein the first player hand includes five cards and the second hand includes two cards.

28. A method according to claim 27, wherein the second payout amount is less if the Joker is in the first player hand than if the Joker is in the second player hand.

29. A method according claim 28, wherein the second payout amount is less than 1 to 1 if the Joker is in the first player hand and 1 to 1 if the joker is in the second player hand.

30. A method according to claim 29, wherein the second payout amount is one of 9 to 10, 4 to 5, 7 to 10, 3 to 5, 1 to 2 or 2 to 5 if the Joker is in the first player hand.

31. A computer-implemented method of providing a Pai Gow Poker game to one or more players including control logic to enable a computer to perform the steps comprising:
a) receiving a wager from a player;
b) dealing cards to a player and to a dealer from at least one randomly-ordered standard fifty-two card deck with at least one Joker included therein;
c) permitting the player and dealer to divide their cards into first and second player hands and first and second dealer hands, respectively, each of the first and second player hands and the first and second dealer hands having a respective hand rank;
d) comparing the first and second player hands ranks with the first and second dealer hands ranks; and
e) responsive to the rank of the first and second player hands outranking the first and second dealer hand ranks, awarding one of a first payout amount based on the wager received if neither one of the first and second player hands includes a Joker and a second payout amount based on the wager received if either one of the first and second player hands includes a Joker, wherein the first payout amount is greater than the second payout amount.

32. A method according to claim 31, wherein the first payout amount is equal to or greater than the amount of the wager received and second payout amount is less than the amount of the wager received.

33. A method according to claim 31, wherein the second payout amount is less than 1 to 1 when compared with the amount of the wager received.

34. A method according to claim 31, wherein the second payout amount is one of 9 to 10, 4 to 5, 7 to 10, 3 to 5, or 1 to 2.

35. A method according to claim 31, wherein the second payout amount depends on whether the Joker is in the first or second player hand.

36. A method according to claim 31, wherein the first player hand includes five cards and the second hand includes two cards.

37. A method according to claim 36, wherein the second payout amount is less if the Joker is in the first player hand than if the Joker is in the second player hand.

38. A method according claim 37, wherein the second payout amount is less than 1 to 1 if the Joker is in the first player hand and 1 to 1 if the joker is in the second player hand.

39. An electronic game device enabling players to play a Pai Gow Poker game including control logic configured for providing the steps comprising:
a) receiving a wager from a player;
b) dealing cards to a player and to a dealer from at least one randomly-ordered standard fifty-two card deck with at least one Joker included therein;
c) permitting the player and dealer to divide their cards into first and second player hands and first and second dealer hands, respectively, each of the first and second player hands and the first and second dealer hands having a respective hand rank;
d) comparing the first and second player hands ranks with the first and second dealer hands ranks; and
e) responsive to the rank of the first and second player hands outranking the first and second dealer hand ranks, awarding one of a first payout amount based on the wager received if neither one of the first and second player hands includes a Joker and a second payout amount based on the wager received if either one of the first and second player hands includes a Joker, wherein the first payout amount is greater than the second payout amount.

40. A method according to claim 31, wherein the first payout amount is 1 to 1 and the second payout amount is less than 1 to 1.
